(19) United States
(12) Patent Application Publication
(10) Pub. No.: US 2009/0055517 A1
(43) Pub. Date: Feb. 26, 2009

(54) Method for a plug-and-play network device to acquire dual internet protocol addresses

(75) Inventor: Ken Kao, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 11/892,197

(22) Filed: Aug. 21, 2007

(51) Int. Cl. G06F 15/177

(52) U.S. Cl. 709/221

(57) ABSTRACT

The present invention is to provide a method applied to at least a network device connected to a network and enabling the network device to send a request for an Internet Protocol address (IP address) to a DHCP server connected with the network according to the Dynamic Host Configuration Protocol (DHCP) and, in the meantime, automatically generate an IP address according to the automatic link-local IP address allocation protocol. When an IP address is first acquired according to either the DHCP or the automatic link-local IP address allocation protocol, the network device exchanges data with other network device of the same segment by using said IP address first acquired, and constantly trying to acquire another IP address according to either the DHCP or the automatic link-local IP address allocation protocol, so as to effectively reduce the time for acquiring an IP address needed by a conventional network device.

### FIELD OF THE INVENTION

The present invention relates to a method of acquiring Internet Protocol (IP) address, more particularly to a method applied to at least a network device connected to an IP network and enabling the network device to acquire dual IP addresses by simultaneously adopting the Dynamic Host Configuration Protocol (DHCP) and the automatic link-local IP address allocation protocol, so as to effectively reduce the time for acquiring an IP address needed by a conventional network device.

### BACKGROUND OF THE INVENTION

Normally, a plug-and-play network device under the home network structure may acquire its Internet Protocol address (IP address) according to the Dynamic Host Configuration Protocol (hereinafter DHCP in short), Point to Point Protocol over Ethernet (PPPoE), fixed IP address or automatic link-local IP address allocation protocol.

In general, in the case that the DHCP is adopted, for a network device to acquire an IP address and log on to a network, the network device will search for a DHCP server through a network router during its first attempt of establishing a connection with the network. And in response to that, the DHCP server will dynamically allocate an IP address to the network device according to the DHCP which enables the network device to exchange data or signals with other network device of the network by using the allocated IP address.

On the contrary, in the case that the router fails to connect with the network, the network device will broadcast a request for an IP address to the network and constantly search for the DHCP server within a first waiting time (such as 1 second). If there is no response from the DHCP server after the first waiting time, the network device will constantly broadcast requests for an IP address to the network within a second, third and fourth waiting time (such as 9, 13 and 16 seconds) in sequence to search for the DHCP server, and declare that the requests for an IP address according to the DHCP have failed after the fourth waiting time is over.

In the case stated above that search for the DHCP server is failed and therefore no IP address is acquired, the automatic link-local IP address allocation protocol will be adopted to select a proper IP address after the waiting time has passed. In short, the automatic link-local IP address allocation protocol mainly defines a method of intellectually choosing an IP address from a set of reserved private addresses. When the DHCP server is not present in the network, each time the network device is turned on and connected with the Ethernet, the automatic link-local IP address allocation protocol will not be adopted to automatically acquire an IP address until said waiting time has passed (about 40 seconds) which is a waste of time and unsatisfactory. Hence, to develop a method of acquiring dual Internet Protocol addresses and thereby save time and exhibit the characteristic of plug-and-play network device has become an important issue to be solved.

### SUMMARY OF THE INVENTION

For the purpose of solving the problem stated above that it takes a long time for the conventional network device to acquire an IP address, after hard work of research and experiments for a long time, the inventor has developed a method for a plug-and-play network device to acquire dual Internet Protocol addresses of the present invention which spends less time than the conventional method of utilizing the DHCP and the automatic link-local IP address allocation protocol in sequence.

One of the objectives of the present invention is to provide a method for a plug-and-play network device to acquire dual Internet Protocol addresses applied to at least a network device of a network capable of exchanging data with other device. When connected to the network, the network device sends a request for an Internet Protocol address (IP address) to a DHCP server connected with the network according to the Dynamic Host Configuration Protocol (DHCP), and in the meantime, automatically generates an IP address according to the automatic link-local IP address allocation protocol. When an IP address is first acquired according to either the DHCP or the automatic link-local IP address allocation protocol, the network device exchanges data with other network device of the same segment by using said IP address first acquired, and constantly trying to acquire another IP address according to either the DHCP or the automatic link-local IP address allocation protocol. Hence, in the case that the DHCP server is not presented in the network, the network device may acquire an IP address automatically according to the automatic link-local IP address allocation protocol without waiting for a period of time, thus spends less time than the conventional method which won't be able to acquire an IP address according to the automatic link-local IP address allocation protocol until its attempt of acquiring an IP address according to the DHCP fails for a predetermined number of times.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 shows a network composed of network devices, a switch and a DHCP server; and

FIG. 2 is a flowchart of an embodiment of the present invention.

### DETAILED DESCRIPTION OF THE PREFERRED EMBODIMENT

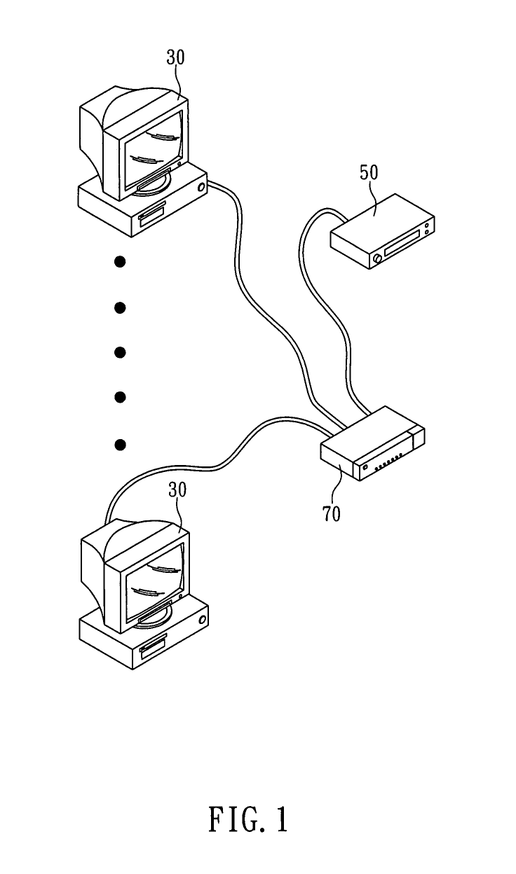

Please refer to FIG. 1, the present invention relates to a method for a plug-and-play network device to acquire dual Internet Protocol addresses applied to at least a network device 30 (such as a computer system capable of establishing a connection with a network or other embedded system like a web cam, Internet phone, set-top box etc.). The network device 30 may exchange data with other network device through a network formed by connecting each other (such as an IP network like Ethernet, wireless network or broadband network etc.). The network device 30 may request an Internet Protocol address (IP address for short), i.e. a first IP address, from a DHCP server 50 connected with the network according to the Dynamic Host Configuration Protocol (DHCP for short), and in the meantime (simultaneously), automatically generate another IP address, i.e. a second IP address, according to the automatic link-local IP address allocation protocol. Hence, when the DHCP server 50 is acquired and connected through a switch 70 connected with the network, the network device 30 will be allocated an IP address from the DHCP server 50 according to the DHCP, the network device may then exchange data with other network device 30 of the same segment by using said IP address. In the meantime, the network device 30 will constantly request another IP address according to the automatic link-local IP address allocation protocol, and exchange data with other network device 30 by using the IP address with the same format as that of other network device 30 (either the first or second IP address) when another IP address is acquired.

On the contrary, in the case that the switch 70 is not connected with the network or the DHCP server 50 is not found and therefore fails to acquire an IP address from the DHCP server 50, still the network device 30 may automatically generate another IP address according to the automatic link-local IP address allocation protocol, and exchange data with other network device 30 of the same segment by using said another IP address after it is determined that said another IP address is correct. With this method, the time spent for the network device 30 to acquire an IP address will be definitely less than that of the conventional method that the network device won't be able to generate an IP address according to the automatic link-local IP address allocation protocol until the attempt of acquiring an IP address according to the DHCP fails for a predetermined number of times.

Moreover, while exchanging data with other network device 30 by using said another IP address, the network device 30 is constantly sending requests for IP address according to the DHCP until the network device 30 acquires the DHCP server 50, establishes a connection with the DHCP server, and is allocated an IP address from the DHCP server. Thus, the network device 30 may choose from said IP address or said another IP address for data exchange with other network device 30.

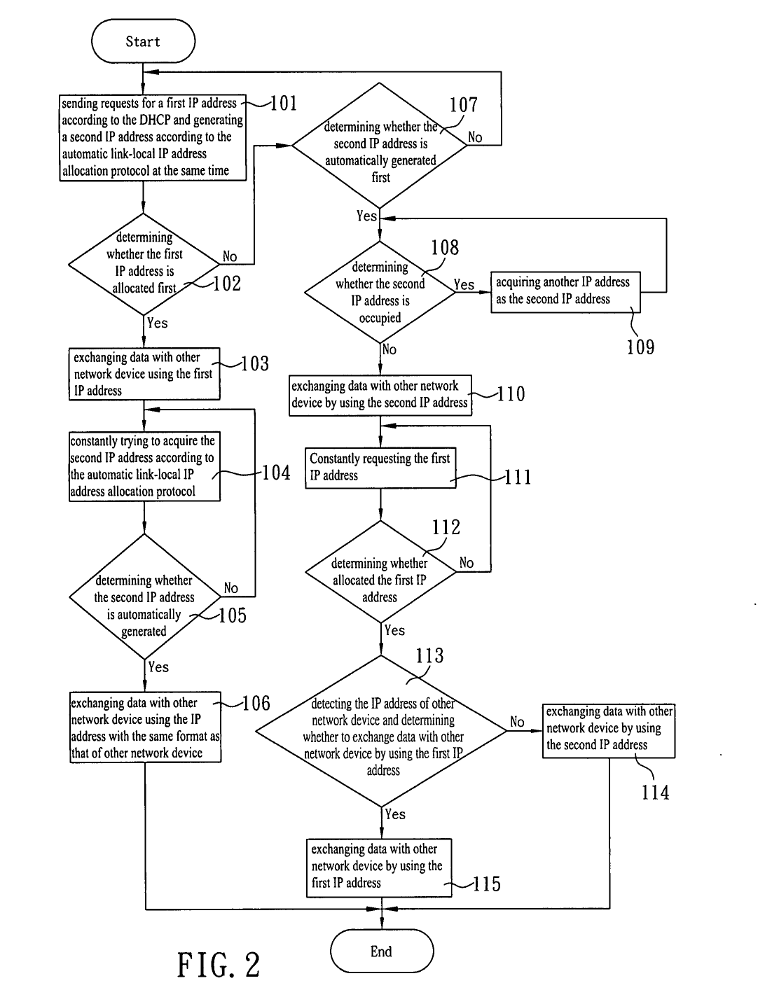

Please refer to FIG. 2, in one preferred embodiment of the present invention, when connected to a network, the network device 30 performs following steps:
(101) searching for a DHCP server 50 in current network and sending a request for a first IP address according to the DHCP, and in the meantime, automatically generating a second IP address within a range of 169.254.x.x according to the automatic link-local IP address allocation protocol;
(102) determining whether the DHCP server 50 is acquired and the network device 30 is allocated the first IP address (such as 192.168.x.x) from the DHCP server 50 first, proceeding to step (103) when affirmative, otherwise proceeding to step (107);
(103) exchanging data with other network device 30 by using the first IP address when the network device 30 is allocated the first IP address from the DHCP server 50 first;
(104) automatically generating the second IP address according to the automatic link-local IP address allocation protocol while exchanging data with other network device 30 by using the first IP address;
(105) determining whether the second IP address is automatically generated according to the automatic link-local IP address allocation protocol (such as 169.254.0.1), proceeding to step (106) when affirmative, otherwise returning to step (104);
(106) exchanging data with other network device 30 by using either the first or second IP address with the same format as that of other network device 30 (such as 192.168.x.x or 169.254.x.x) since the network device 30 is provided with both the first and second IP addresses (IP aliasing) at the same time and terminating this process.
(107) determining whether the second IP address (such as 169.254.0.1) is automatically generated first according to the automatic link-local IP address allocation protocol, proceeding to step (108) when affirmative, otherwise returning to step (101);
(108) determining whether the second IP address acquired is occupied by other network device 30 through declaring the second IP address to other network device 30 after the second IP address is automatically generated according to the automatic link-local IP address allocation protocol, proceeding to step (109) when affirmative, otherwise proceeding to step (110);
(109) generating another second IP address (an IP address other than 169.254.0.1) within the range of 169.254.x.x since the second IP address is occupied by other network device 30, and returning to step (108) to declare its newly generated IP address to other network device 30 and ensure the uniqueness of it;
(110) exchanging data with other network device 30 by using the second IP address;
(111) constantly searching the DHCP server 50 in current network and sending requests for a first IP address while exchanging data with other network device 30 by using the second IP address;
(112) determining whether the DHCP server 50 is acquired and the network device 30 is allocated an IP address as the first IP address, proceeding to step (113) when affirmative, otherwise returning to step (111);
(113) detecting the IP address used by other network device 30 and determining whether to exchange data with other network device 30 by using the first IP address since the network device 30 has acquired the DHCP server 50 and been allocated an IP address as the first IP address which makes the network device 30 to be provided with dual IP addresses (IP aliasing), i.e. the first IP address (192.168.x.x) and the second IP address (169.254.x.x), and proceeding to step (115) when affirmative, otherwise proceeding to step (114);
(114) maintaining the status of exchanging data with other network device 30 by using the second IP address; and
(115) exchanging data with other network device 30 by using the first IP address and terminating this process.

In the case that the conventional method for a network device to acquire an IP address is adopted, not until multiple periods of waiting time for the network device to search for the DHCP server has passed (about 40 seconds) will the IP address be automatically generated according to the automatic link-local IP address allocation protocol (takes about 10 seconds), and therefore it takes about 50 seconds to acquire an IP address. However, in the case that the DHCP server has been removed from the network, it takes only about 10 seconds to go through the process of the automatic link-local IP address allocation protocol and automatically generate an IP address according to the method of the present invention which is absolutely less than that of the conventional method and thus the present invention should be entitled to patent for its novelty and non-obviousness.

It should be noted that though the network device 30 establishes a connection with a transmission line in the above embodiments, while the present invention is implemented, however, the network is not limited to an Ethernet but may be other IP network like a LAN, Wireless LAN or Powerline Communication. Besides, the DHCP server 50 in the above embodiments may also be installed in the switch 70.

While the invention herein disclosed has been described by means of specific embodiments, numerous modifications and variations could be made thereto by those skilled in the art without departing from the scope and spirit of the invention set forth in the claims.

What is claimed is:

1. A method for a plug-and-play network device to acquire dual Internet Protocol addresses applied to at least a network device of a network capable of exchanging data with other device, comprising:
sending requests for a first Internet Protocol address (IP address) to a DHCP server connected with said network according to the Dynamic Host Configuration Protocol (DHCP for short), and in the meantime, automatically generating a second IP address according to the automatic link-local IP address allocation protocol; and
while an IP address is first acquired according to either the DHCP or the automatic link-local IP address allocation protocol, exchanging data with other network device by using said IP address.

2. A method for a plug-and-play network device to acquire dual Internet Protocol addresses of claim 1, wherein after said IP address is acquired according to one of the DHCP and the automatic link-local IP address allocation protocol, said network device constantly tries to acquire another IP address according to the other protocol.

3. A method for a plug-and-play network device to acquire dual Internet Protocol addresses of claim 2, wherein acquiring said first IP address according to the DHCP further comprising:
sending a request for said first IP address to said DHCP server acquired in said network;
determining whether said first IP address is allocated from said DHCP server first; and
exchanging data with other network device by using said first IP address when it is determined that said network device is first allocated said first IP address.

4. A method for a plug-and-play network device to acquire dual Internet Protocol addresses of claim 3, wherein while exchanging data with other network device by using said first IP address, said method further comprising:
constantly requesting for said second IP address according to the automatic link-local IP address allocation protocol;
determining whether said second IP address is acquired; and
exchanging data with other network device by using either said first or second IP address with the same format as that of other network device when said network device is provided with said first and second IP address at the same time.

5. A method for a plug-and-play network device to acquire dual Internet Protocol addresses of claim 2, wherein acquiring IP address according to the automatic link-local IP address allocation protocol further comprising:
acquiring said second IP address within the range of 169.254.x.x according to the automatic link-local IP address allocation protocol; and
exchanging data with other network device by using said second IP address after it is determined that said second IP address is correct.

6. A method for a plug-and-play network device to acquire dual Internet Protocol addresses of claim 5, wherein while exchanging data with other network device by using said second IP address, said method further comprising:
constantly searching for said DHCP server in said network and sending requests for said first IP address;
determining whether allocated said first IP address from said DHCP server;
detecting the IP address used by other network device while said network device is provided with said first and second IP address at the same time, and determining whether to exchange data with other network device by using said first IP address; and
exchanging data with other network device by using said first IP address when affirmative.

7. A method for a plug-and-play network device to acquire dual Internet Protocol addresses of claim 5, wherein determining whether said second IP address is correct further comprising:
declaring said second IP address to other network device of said network;
determining whether said second IP address is occupied by other network device; and
acquiring another second IP address different from said second IP address within the range of 169.254.x.x when it is determined that said second IP address is occupied by other network device, and returning to the step of declaring said second IP address to other network device of said network.
